(19) United States
(12) Patent Application Publication
(10) Pub. No.: US 2006/0089941 A1
(43) Pub. Date: Apr. 27, 2006

(54) Data source objects for producing collections of data items

(75) Inventors: David J. Jenni, Sammamish, WA (US); Namita Gupta, Seattle, WA (US); Samuel W. Bent, Bellevue, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 10/971,800

(22) Filed: Oct. 21, 2004

(51) Int. Cl. G06F 17/00

(52) U.S. Cl. 707/102

(57) ABSTRACT

Described are data source objects, which provide data from a resource to an application program, such as a data collection for binding to user interface elements. A data source that matches a resource type is specified by an application program, such as via markup language (e.g., XAML). At runtime, a data source object is instantiated as an indirection between the resource and the application data, e.g., the data collection bound to a user interface element. The data source object retrieves data from the data provider resource via asynchronous and/or background communication operations, and with marshaling the data as necessary to deliver it on the original user interface context. Data sources provide integration to major data models, including CLR objects, XML, Sql/ADO, and WinFS, supporting straightforward declarative and parameterized queries while allowing customized behavior using code for more advanced scenarios. An application can define its own customized data source objects.

### CROSS-REFERENCE TO RELATED APPLICATION

The present invention is related to U.S. patent application Ser. No. ______, entitled “Collection View Objects for Displaying Data Collection Items in User Interface Elements,” filed concurrently herewith, assigned to the assignee of the present invention and hereby incorporated by reference in its entirety.

### FIELD OF THE INVENTION

The invention relates generally to computer programs and data, and more particularly to providing computer program data for use by application programs.

### BACKGROUND

Contemporary operating systems offer various data models along with a rich set of application programming interfaces (APIs) to access and manipulate the data. For examples, APIs allow access to XML (extensible Markup Language) data, SQL data, ADO (ActiveX® Data Objects), CLR (common language runtime) objects, WinFS (windows® file system) objects, and so forth. Common to any of these data and objects, to produce their data for consumption by an application program requires multiple programmatic calls into a respective API, using C# or other managed languages.

However, many application authors do not want to deal with programming languages, and/or prefer a more high-level solution, such as provided by a markup language. For example, XAML (extensible Application Markup Language) is Microsoft® Corporation's relatively new XML-based declarative markup language that is generally designed to simplify much of the authoring needed in writing application programs.

Moreover, many data provider APIs only support synchronous method calls to produce the data. Depending on the nature of the source, this can take considerable time (a few seconds to minutes), which is often aggravated by error conditions such as when a remote SQL server cannot be reached over a defunct LAN. Where such a method called during user interface-related operations, for example during operation of a button's click handler, the program's user interface (UI) freezes and remain non-interactive until the API call returns with the data or returns with a timeout error.

Most APIs therefore offer additional methods to allow processing the queries in the background, using asynchronous versions of the methods. However, such asynchronous communications require the application author to have a greater amount of programming expertise and/or to learn substantial amounts of material in order to correctly author the program. For example, with asynchronous communications it is necessary to program a state machine, as well as author the program to handle multithreaded callbacks and perform the necessary marshaling to deliver the resulting data on the correct/original UI context thread.

In sum, programming models are being made available that allow programs to be authored via relatively easy-to-use markup languages such as XAML. Heretofore, however, a substantial amount of logic and programming skill was needed to avoid freezing the user interface, by obtaining data in an asynchronous manner that correctly handles various states and multithreading requirements. What is needed is a way through straightforward programming concepts (e.g., via markup language declaratives) to produce data for application programs from various data sources, in a manner that does not freeze other parts of a program while eliminating the need for complex programming.

### SUMMARY OF THE INVENTION

Briefly, the present invention is directed towards a system and method by which a data source object retrieves data from a data provider resource for an application program, while handling much of the complexity needed to handle asynchronous and/or background communication operations, along with marshaling the data as necessary to deliver it on the original context. In general, an application has data and via markup specifies user interface (UI) elements (e.g., text boxes, image boxes, list boxes and so forth) that need to bind to the data. The data source object produces collections of data items that an application program uses to display in the UI elements.

Markup identifies a resource and its properties, including a data source. The markup also specifies a UI element to which data from the data source is to be bound. At the time of binding, a binding engine instantiates a data source object to provide an indirection between the resource and the data items that the resource provides.

After instantiation, the data source object communicates with the data provider resource to produce the application program data, such as by filling a data collection object, where, for example, one or more collection view objects present respective views of the data via program-specified user interface elements.

The data source object includes an IDataSource interface that handles queries to produce the data items, as well as to deliver the data items and to be notified when new data is available. The interface enables data to be retrieved as needed; a refresh method allows applications to change the parameters of the data source and rerun the query. A data changed event is fired once the query is complete, at least to some threshold amount of returned data.

The data source object executes the data producing query asynchronously, and/or in the background, and signals to the binding engine application program when data is available. More particularly, the data source objects implement queries using corresponding asynchronous methods if available, or if not, execute the query in a background thread. When data is ready, the data source objects correctly marshal the data back to the original UI Context thread, and then signal the data binding engine that it can now evaluate its depending data bindings to produce UI output. This relieves the application program author from needing to have to program multithreading/background processing, but still allows the author to write applications that do not freeze the UI while data is being queried from a data provider, e.g., a remote SQL server.

The present invention thus allows the definition of a data source in XAML markup, and allows data to be declaratively brought into an application program. Data source objects correspond to major data models, including CLR objects, XML, and Sql/ADO, e.g., via ObjectDataSource, XmlDataSource, and SqlDataSource data source objects. Custom data source objects may be built.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an architecture/framework into which data source objects may be instantiated, in accordance with various aspects of the present invention; and

FIG. 3 is a block diagram generally representing the relationships between a data provider, a data source object and a data collection which may have its data items mapped through one or more collection views, in accordance with various aspects of the present invention.

### DETAILED DESCRIPTION

Exemplary Operating Environment

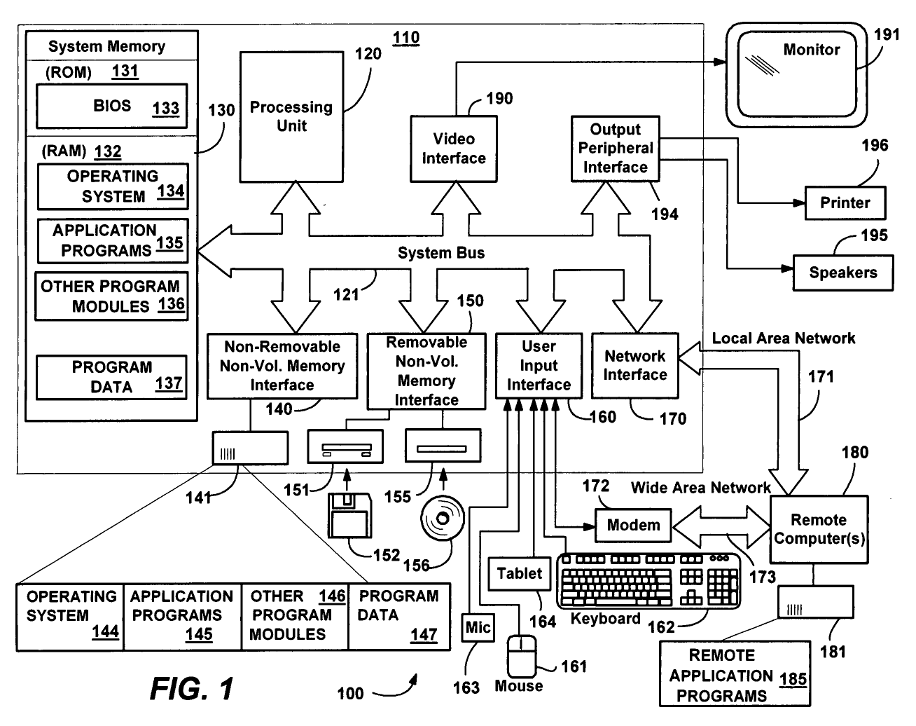

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Note that as described below, the present invention is generally directed towards data sources, which may, for example, include data sources corresponding to a SQL server and/or XML data provider (web service), that reside on one or multiple remote systems. The computing environment 100 of FIG. 1 is understood to include any local and/or remote source of data, including the SQL server-provided data, web service server provided data, and others.

Data Sources

The present invention is generally directed towards a system and method by which a data source object retrieves data from a data provider resource for an application program, while handling much of the complexity needed to handle asynchronous and/or background communication operations, along with marshaling the data as necessary to deliver it on the original context. As will be understood, numerous ways to implement the present invention are feasible, and only some of the alternatives are described herein. For example, the present invention enables the use of markup languages to retrieve data, and thus the present invention is described with numerous examples that use XAML. As such, the present invention is not limited to any particular examples used herein, but rather may be used various ways that provide benefits and advantages in computing in general.

In general, an application has data and via markup specifies user interface (UI) elements (e.g., text boxes, image boxes, list boxes and so forth) that need to bind to the data. The present invention provides declarative factories for data items to be used as sources of data bindings. In other words, a data source object behaves like a factory to produce collections of data items that an application program uses, such as to display data items in UI elements. For example, consider the following (XAML) markup:

```
<Panel>
  <Panel.Resources>
    <ObjectDataSource def:Name=“ODS” TypeName=“Customer1” />
  </Panel.Resources>
  <ListBox ItemsSource=”*Bind(DataSource={ODS}; ...)” />
</Panel>
```

As can be seen, the first part of the markup identifies a resource and its properties, with the resource being of type object data source, named “ODS” and having a type name of Customer1. The resource may have other properties, but they are not shown in this example. Object data source is one type of resource; other types are described below.

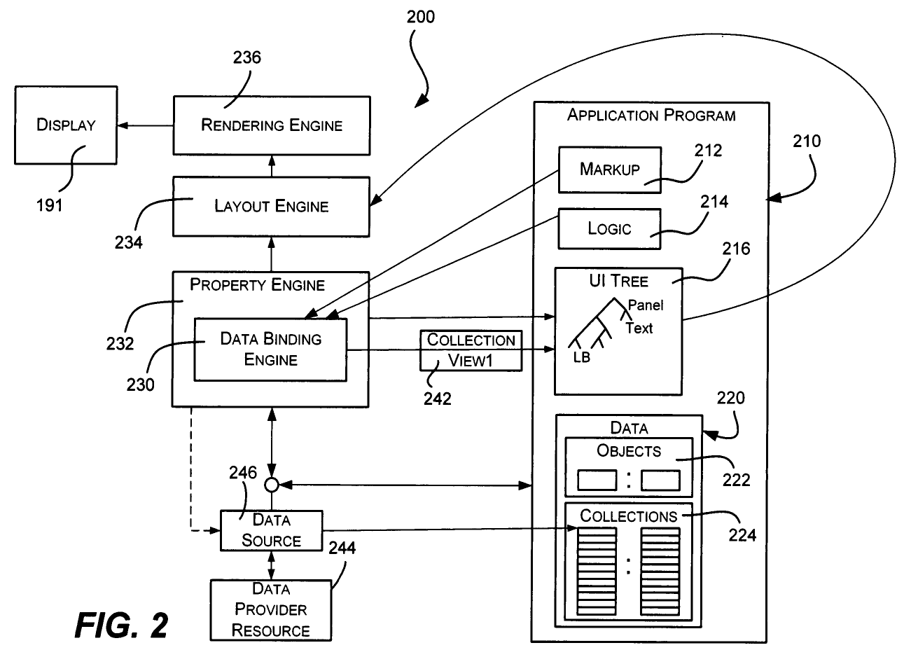

The next part of the markup, the ListBox tag, specifies a UI element to which data is to be bound, namely the data from the DataSource named “ODS” in the markup. At the time of binding, the data source property is seen on the binding description, (by the binding mechanism described below with reference to FIG. 2), whereby it is known that the binding of the UI element is to the data items of the resource object (as opposed to the resource object itself). A data source object is thus instantiated by the binding mechanism to provide an indirection between the resource and the data items that the resource provides.

FIG. 2 generally describes data binding, in which an example architecture and framework 200 communicates with an application program 210 containing (e.g., XAML-formatted) markup 212 and logic 214. In general, at runtime, the markup 212 is interpreted, possibly in conjunction with the logic 214, to construct a hierarchical UI tree 216. For example, the UI tree 216 may contain nodes that represent a panel, some text and a ListBox (LB) along with other nodes. The tree 216 may be built from various data, including data placed directly in the markup 212, and application data 220, including collection objects 222 and other data objects 224 that are bound to the application program 210 by a data binding engine 230 of a property engine 232.

In general, the data binding engine 230 connects the data objects to the objects in the UI tree 216, while the property engine 232 manipulates the UI objects in the tree 216 such as to keep them updated. Note that the UI tree 216 and data 220 are shown as being part of the application program 210, but in actuality the UI tree is a section of memory reserved for that particular program, and the data 220 may come from an external data provider resource 244, in accordance with various aspects of the present invention. In the exemplary architecture and framework 200, a layout engine 234 processes the tree 216, essentially walking the tree to determine the size and position of the objects, and a rendering engine 236 that outputs graphics to the display, such as the monitor 191 of FIG. 1.

To view the data, FIG. 2 shows a collection view object 242₁, which couples user interface elements to data items of the data collection, where the collection view may have its own sort order, filter and/or grouping criteria with respect to presenting the data items of the collection, as well as semantics related to the concept of a current item. Collection view objects are described in the aforementioned U.S. patent application entitled “Collection View Objects for Displaying Data Collection Items in User Interface Elements.” Multiple collection views are feasible, such as to present simultaneous multiple views of the same data, which typically are sorted filtered and/or grouped differently, and may have different current items.

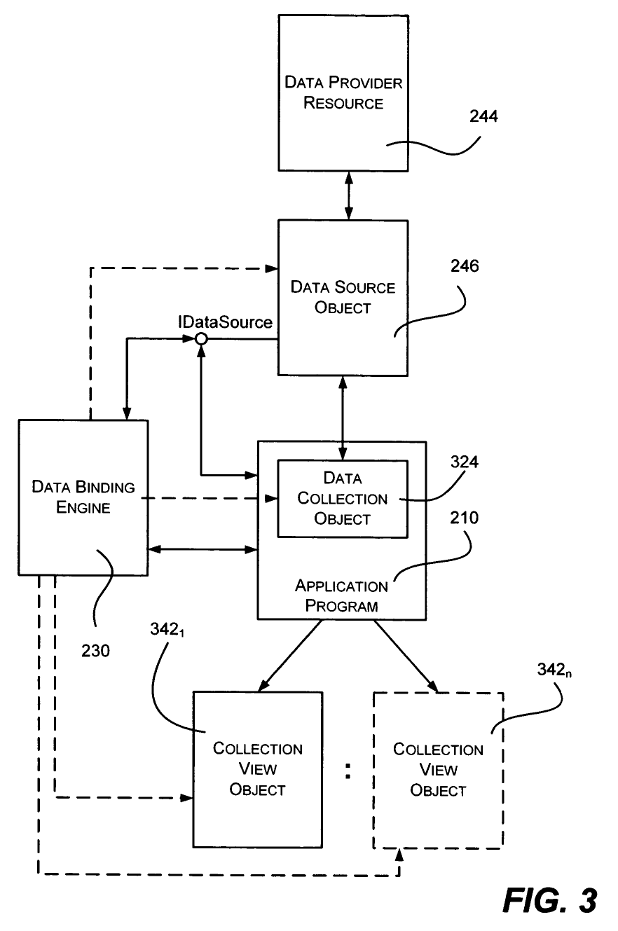

In accordance with an aspect of the present invention and as generally represented in FIG. 2, a data source object 246 communicates with a data provider 244 to produce the data for a data collection within the set of one or more data collections 224. More particularly, as represented in FIG. 3, in one implementation the data source object 246 is instantiated (as indicated by the dashed line in FIG. 2) by the data binding engine 230, e.g., as a result of the markup 212. The data source object 246 provides an IDataSource interface that couples the data source object 246 to the data binding engine 230/application program 210 for retrieving the data from the data provider resource 244. The results of data retrieval are provided to the application program, such as to a data collection object, labeled 324 in FIG. 3, where, for example, one or more collection view objects 342₁ and 342ₙ present respective views of the data via program-specified user interface elements.

To allow uniform interaction of the data binding engine 230 with any data provider (including third party data providers), the IDataSource interface provides queries to produce the data items, as well as to deliver the data items and to be notified when new data is available. In keeping with the present invention, the data source object also executes the data producing query in the background, and signals to the binding engine 230/application program 210 when data is available. This relieves the application program author from needing to have to program multithreading/background processing, but still allows the author to write applications that do not freeze the UI while data is being queried from a data provider, e.g., a remote SQL server.

As described above, the present invention allows the definition of a data source completely in XAML markup, and allows data to be declaratively brought into an application program. Data sources do not define new data models, but rather provide integration to major data models, including CLR objects, XML, Sql/ADO, and WinFS. For these data models, data sources have been developed, e.g., ObjectDataSource (described above), XmlDataSource, and SqlDataSource, and support straightforward declarative and parameterized queries, while allowing access to the underlying original data provider API to further customize the behavior using code for more advanced scenarios. The necessary parameterization of the queries to produce the data can be expressed in XAML tags and attributes, e.g., the name of a SQL server and the required SQL SELECT command, as described in the example below of the SQL data source. The data source concept is extensible and provides a generic interface that allows different data providers of third parties as well as application writers to build their own data sources.

In accordance with another aspect of the present invention, the data source objects provide support for asynchronous non-UI blocking access to data. To this end, the data source objects implement the queries using corresponding asynchronous methods if available, or if not, execute the query in a background thread. When data is ready, the data source objects correctly marshal the data back to the original UI Context thread, and then signal the data binding engine 230 that it can now evaluate its depending data bindings to produce UI output, (e.g. fill a list box).

IDataSource is a common interface for the various types of data sources; lengthy operations are asynchronous and fire DataChanged events, and a Refresh( ) method is provided:

```
interface IDataSource
{
    void Refresh( );
    object Data { get; }
    event EventHandler DataChanged;
}
```

Implementations of IDataSource do not have to be part of the UI tree, and are added as objects to a ResourceDictionary and hence do not have to inherit from a UIElement or a DependencyObject. As mentioned above, to use a data source, it is commonly referenced in a data binding expressions, as in the following alternative example of an XMLDataSource object:

```
<DockPanel>
    <DockPanel.Resources>
      <XmlDataSource def:Name=”DS1” XPath=”. . .” ... />
    </DockPanel.Resources>
    <ListBox ItemsSource=”*Bind(DataSource={DS1}” />
</DockPanel>
```

The application programmer expects that a data source gets the necessary parameters passed in as markup attributes, and that the query is executed, with no extra C# code needed. The product of the query is an object that can be consumed as UI binding's DataContext, typically of type collection (with or without dynamic support using ICollectionChange/IBindingList), of type DataSet, or of type object. This is represented in FIG. 3 as the data collection object 324. Note that because the data source object is a resource object, in one implementation, the creation of the data source object is deferred until the first usage within a page.

Each data source object may return a specialized object collection that may choose to implement ICollectionViewFactory. Thus, as described in the aforementioned U.S. patent application entitled “Collection View Objects for Displaying Data Collection Items in User Interface Elements,” collection view objects, the CollectionView object also may be a special implementation matching the data source's topology. This allows for CollectionView.Sort( ) and CollectionView.Filter to take advantage of the underlying data provider, e.g. for SqlDataSource, the implementation of Sort/Filter delegates to DataSet or SqlClient API. Many data sources will have more domain-specific methods to manipulate the data, and/or for example, will support writing back changed data to the persistent store of the data provider 244.

With respect to the DataChanged event, the data binding engine 230 is set to detect when the event fires, which occurs whenever the data property has a new instance of a data collection assigned to it. For example, if the application wants to replace the “Customer1” TypeName with another one, the application will provide the new name and call the Refresh( ) method of the data source object. This will cause the event to fire, whereby the binding engine will ask for the data property again and reevaluate its dependent binding expressions. Note that this event does not fire when the data within the same collection changes, such as because of added items/rows, as such an event is fired by the collection as a CollectionChanged event.

By way of another, query-based, example, an application also may obtain data from a relational database via a SqlDataSource class. It is parameterized by an SQL query and a ConnectionString, and returns data in the form of a System.Data.DataSet object.

The following example uses property tag syntax to describe the complex Select property:

```
<FlowPanel>
  <FlowPanel.Resources>
    <SqlDataSource def:Name=”TheData”
        ConnectionString=”server=myhost;database=mydata”>
      <SqlDataSource.Select>
        <QueryCommand Text=”SELECT Title, Author, Subject
          FROM Books” Table=”LibraryData” />
      </SqlDataSource.Select>
  </FlowPanel.Resources>
  <Text TextContent=”*Bind( DataSource={TheData};  Path=Title )” />
</FlowPanel>
```

Consider that the above query has been previously made. If the query then changes, the application will call the Refresh( ) method, the data source object will submit the new query, and when it has the new data, will fire the DataChanged event. In essence, the IDataSource interface abstracts the communication maintained between the bindings and the data, so that new queries/data changes are handled. Note that the binding engine need not know anything about SQL, XML and/or the objects, as the details about the queries are isolated to the object, and can be written in markup.

The asynchronous filling of the collection behind the data property happens on the UI thread, as do any changes to the data property. Change/complete events are expected on the originating UiContext, (that is, the user of IDataSource assumes single-threaded behavior/affinity to UiContext).

For an initial query, the code that instantiates a IDataSource implementation (most commonly the data binding engine) calls Refresh( ), (and not the constructor of the data source object). This allows the caller (commonly the markup parser) to set multiple properties such as ConnectionString, and gives elements such as an item generator a chance to hook up to the change events before the initial Refresh is started and the changed events are raised. Changes to the data property and change/complete events are expected on the originating UIContext (i.e. the user of IDataSource assumes affinity to UIContext). It is up to the implementer of IDataSource to either acquire the UIContext or marshal to the UIContext by posting to the UIContext's operations queue.

The data source has several choices for implementing background filling. Common asynchronous strategies include that when Refresh( ) is called, the data source sets its data property to null. Once the new data collection is filled with the query result, the data collection is assigned to the data property and the DataChanged event is raised.

Alternatively, if the data source is capable of providing dynamic, progressive change notifications while the data collection is being filled, the data property is set to an empty data collection instance after the Refresh is called, before the initial DataChanged event is raised. The data source implementation can now fill the collection in the background, raising a collection changed event via the collection's ICollectionChanged interface.

A hybrid of the above alternatives comprises progressive filling of the collection; initially, the data property is set to null. After the query returns a “reasonable” number of rows (e.g. ten percent or some suitable number such as one-hundred rows), a collection with those results is assigned to the Data property and the DataChanged event is raised. The remaining results get added to this collection and raise collection changes while adding rows.

To refresh after the initial query, the application can explicitly call Refresh( ) (or a more domain-specific method on the data source class) to request the data source 246 to reload/re-query the data from its provider store 244. It is up to an implementer of the data source to either recreate a new data collection as with the initial query and raise a DataChanged event, or modify the existing data collection and raise CollectionChanged events. Note that modifying the existing data collection can be more complex and costly on the data source side, but likely will provide better overall performance since the previously-generated UI tree will not have to be torn down and recreated from scratch, but instead only the UI needs to be modified.

Calling Refresh( ) with a older Refresh( ) still running starts another Refresh, it is up to the application to deal with multiple DataChanged events. If the data source cannot support a concurrent refresh, an already running refresh will be prematurely terminated or the data source will raise an exception.

Regardless of the type of data source object, the data source object at least needs to implement the IDataSource interface. This interface does not wrap advanced data model specific APIs such as ADO, XML and so forth. Each data source implementation should also expose a strongly-typed property-get to the native API of the provider; there is no general purpose property on IDataSource for this. For example, for SqlDataSource or XmlDataSource:

| class SqlDataSource : IDataSource | |
|---|---|
| { | |
| . . . . | |
| DataSet | DataSet { get; } |
| . . . . | |
| } | |
| class XmlDataSource : IDataSource | |
| { | |
| . . . . | |
| XmlDocument | Document { get; } |
| . . . . | |
| } | |

As described above, data sources for common types of data may be provided. For XML data, an XmlDataSource allows an application to use XML data via the XmlDataSource class. In markup, it can be used in one of two ways, namely sourced, or inline.

In a sourced use, the XML data is obtained from a URL given by the Source property:

```
<FlowPanel>
  <FlowPanel.Resources>
    <XmlDataSource def:Name=”TheData”
      Source=”http://MegaCorp.com/Customers.xml”/>
  </Flowpanel.Resources>
  <Text TextContent=”*Bind( DataSource={TheData};
  XPath=Name )” />
</FlowPanel>
```

In an inline use, the XML data is denoted directly within the data source:

```
<FlowPanel>
  <FlowPanel.Resources>
    <XmlDataSource def:Name=”TheData” >
      <Library xmlns=””>
        <Book Title=”A Tale of Two Cities”/>
        <Magazine Title=”Newsweek” />
      </Library>
    </XmlDataSource>
  </FlowPanel.Resources>
  <Text TextContent=”*Bind( DataSource={TheData};
XPath=Book/@Title )” />
</FlowPanel>
```

An application can use data source objects defined by the application program via an ObjectDataSource class. The parameter in this case is given by the TypeName property, which denotes either a fully qualified type name, or a name defined in the “code-behind” for the application.

The following is an example of a fully-qualified type name. The example includes the namespace of the desired class, and the name of the assembly in which it is defined.

```
<FlowPanel>
  <FlowPanel.Resources>
    <ObjectDataSource def:Name=”TheData”
      TypeName=”MyNamespace.Customers, MyApp”/>
  </FlowPanel.Resources>
  <Text TextContent=”*Bind( DataSource={TheData};  Path=Name )” />
</FlowPanel>
```

This markup looks in the assembly named MyApp for a class named MyNamespace.Customers, creates an instance of this class, and uses it as the source for the data association.

As can be seen from the foregoing detailed description, there is provided a method and system including data source objects that enable straightforward programming concepts (e.g., via markup) to produce data for application programs from various data sources. The data source objects handle communication with the resource in a manner that does not freeze other parts of a program, while eliminating the need for complex programming. The present invention thus provides numerous benefits and advantages needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
processing information that identifies a data resource and binds an application program-specified element to data of the data resource; and
associating a data source object with the data resource and the element, the data source object obtaining the data from the data resource.

2. The method of claim 1 wherein processing the information comprises interpreting markup language code.

3. The method of claim 1 wherein processing the information comprises interpreting extensible application markup language code (XAML).

4. The method of claim 1 wherein processing the information comprises detecting information that identifies a data source object.

5. The method of claim 1 wherein associating the data source object with the data resource and the element comprises instantiating the data source object at runtime.

6. The method of claim 1 wherein obtaining the data from the data resource comprises querying from the data source object to the data resource.

7. The method of claim 6 wherein the querying is performed via asynchronous communication.

8. The method of claim 6 wherein the querying is performed via a background thread.

9. The method of claim 1 wherein associating the data source object with the data resource and the element comprises binding the data to a user interface element.

10. The method of claim 9 further comprising, instantiating a collection view object to provide a view of the data via the user interface element.

11. The method of claim 1 wherein the data source object includes an interface, and further comprising, receiving a method call on the interface to refresh data from the data resource, and communicating from the data source object to the resource to obtain refreshed data.

12. The method of claim 11 further comprising, firing an event when the refreshed data is received from the resource.

13. At least one computer-readable medium having computer-executable instructions, which when executed performing the method of claim 1.

14. In a computing environment, a system comprising:
a data source object including an interface by which queries for data may be requested; and
a data binding engine that binds a data provider resource to an application program-specified element via the data source object, the data source object making at least one query to the data provider resource to obtain data for use in the application program-specified element.

15. The system of claim 14 wherein the data binding engine instantiates the data source object.

16. The system of claim 14 wherein the application program-specified element comprises a user interface element.

17. The system of claim 16 wherein the user interface element comprises a listbox control.

18. The system of claim 16 wherein the user interface element comprises a text control.

19. The system of claim 16 wherein the user interface element comprises an image control.

20. The system of claim 14 wherein the element is identified in a tag of a markup language and wherein the data binding engine binds the element to a data source object identified within the tag.

21. The system of claim 20 wherein the data source object is named within the tag.

22. The system of claim 14 wherein the data source object further includes a refresh method called via the interface.

23. The system of claim 22 wherein the data source object communicates with the data provider resource when a call to the refresh method is received, and wherein the data source object fires an event when data is received from the data provider resource.

28. The system of claim 18 wherein the data source object corresponds to a common language runtime object data model.

28. The system of claim 18 wherein the data source object corresponds to an XML data model.

29. The system of claim 18 wherein the data source object corresponds to a SQL data model.

30. At least one computer-readable medium having computer-executable instructions, which when executed perform steps, comprising:
processing markup language, the markup language including a tag for a user interface element and a reference to a data source that corresponds to a data provider resource; and
instantiating a data source object corresponding to the data source markup, the data source object logically between the data provider resource and an application program data structure to retrieve data for the application program.

31. The computer-readable medium of claim 30 further comprising, providing an interface to the data source object, the interface providing a mechanism for retrieving data from the data provider resource.

32. The computer-readable medium of claim 30 further comprising, providing an interface to the data source object, the interface providing a mechanism for calling to retrieve data from the data provider resource.

33. The computer-readable medium of claim 32 further comprising, waiting at the data source object until at least some threshold amount of data has been received, and when the threshold amount is received, firing an event.

34. The computer-readable medium of claim 30 wherein the data retrieved for the application program is obtained via asynchronous communication between the data source object and the data provider resource.

35. The computer-readable medium of claim 30 wherein the data retrieved for the application program is obtained via communication between the data source object and the data provider resource on a background thread.

36. The computer-readable medium of claim 30 wherein the data is retrieved on a first context, wherein the application data is processed on a second context, and wherein the data source object marshals the retrieved data from the first context to the second context.

37. The computer-readable medium of claim 30 wherein the application program data structure comprises a user interface element, and further comprising, instantiating a collection view to provide a view of the application program data via the user interface element.
